(19) United States
(12) Patent Application Publication
(10) Pub. No.: US 2015/0233160 A1
(43) Pub. Date: Aug. 20, 2015

(54) Force Closer

(71) Applicant: Mikhail Aleczandar Rogers, Ashland, MA (US)

(72) Inventor: Mikhail Aleczandar Rogers, Ashland, MA (US)

(21) Appl. No.: 14/180,354

(22) Filed: Feb. 14, 2014

(51) Int. Cl. E05C 19/16

(52) U.S. Cl. CPC E05C 19/16

(57) ABSTRACT

Placing a newborn in a crib and hoping for a full night of sleep can be difficult enough, but to have your child start crying because of the ‘click’ of a closing door latch can be frustrating.

Your five year old is having a ‘play date’ and their friend decides to press the button that locks the door to their room. Asking them to open the door and not getting a response can put you in a frenzy looking for something to unlock the door. Cover the door handle or replace the latch?

In both cases, something that could close the door quietly and without allowing it to lock would be ideal. The solution? The Force Closer. Replace the locking spring latch and strike plate with something designed to fit easily and exactly in its place. With a magnet in the door and a steel slug in the door frame, or a Force Closer in both locations for more closing power, there is a new way to close a door.

### FEDERALLY SPONSORED RESEARCH

N/A

### SEQUENCE LISTING

N/A

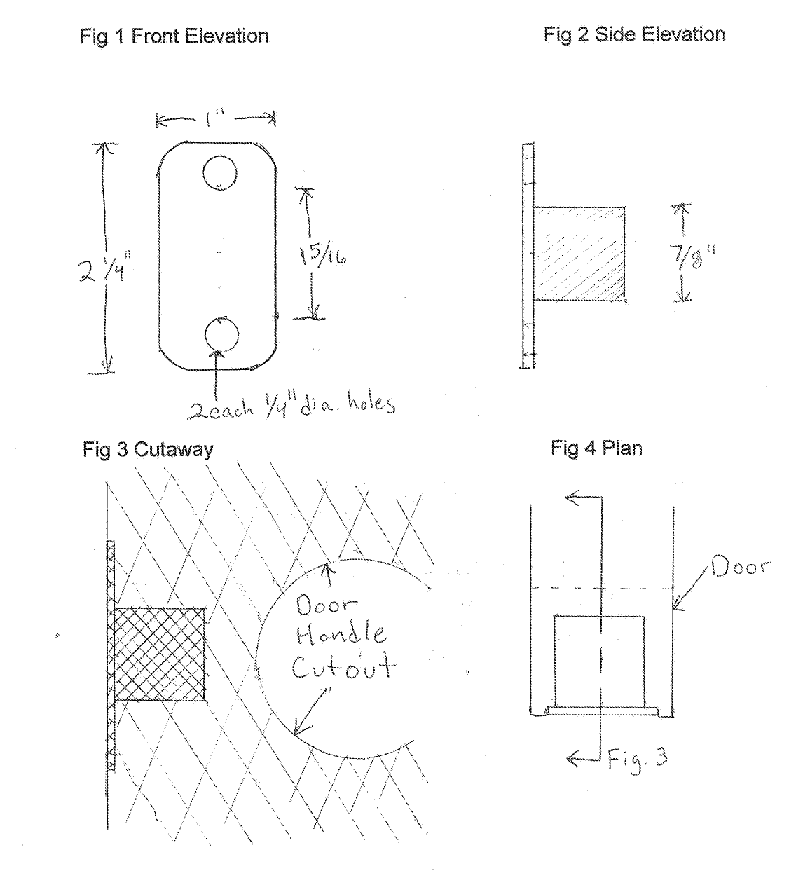

FIG. 1 Front Elevation: A view of the only exposed portion of a Force Closer once installed in the edge of a door opposite the side that includes the hinges, showing dimensions that match the typical cutout of a majority of interior doors (not including antique mortised latches). These dimensions should include variations including a 1⅛″ width and also squared corners.

FIG. 2 Side Elevation: The side view of a Force Closer consisting of a ⅛″ thick metal plate (typically brass, but may be another material including brass plated steel, or even plastic) with a ⅞″ diameter magnet of a varying length glued to said plate.

FIG. 3 Cutaway: A view showing the Force Closer in its intended position and its relation to the cutout of a typical interior residential door. The Force Closer has taken the position of a latch and this view does not show the door handle (which would be located in the 2⅛″ diameter hole marked by ‘door handle cutout’).

FIG. 4 Plan: A top down view of an interior residential door showing a theoretical cutaway view (FIG. 3) of the location of a Force Closer installed in the door latch positions (only the ‘face’ of the Force Closer would be exposed when installed—see FIG. 1

### SUMMARY

Two Force Closers installed together will hold the door closed. If the magnet of one Force Closer is replaced with a ⅞″ diameter steel slug, it will still operate in a similar manner.

This latch replacement is created by adhering a magnet to a base plate (FIG. 2), both of which have dimensions (FIG. 1) sized to fit exactly the cutout made for a door latch, and found on most residential doors. It is intended as an improvement or replacement of mechanical latches and can be installed easily on new doors in conjunction with a door handle, or installed on doors with existing latches by removing the door handle, removing the door latch, installing the Force Closer (FIG. 3), then reinstalling the door handle. With the Force Closer installed, the door can be closed quietly simply by pushing it towards the closed position. Then the Force Closer will hold the door closed even if a gust of wind or a small animal pushed on it. This is beneficial in the case of a babies nursery because the door can be opened hands free (with the push of a hip) and closed quietly (so as not to disturb a sleeping baby) and still keep out small pets. A Force Closer would be beneficial on a childs bedroom door because it would prevent the door from being locked from the inside.

1. The Force Closer is the only magnetic closure designed as a latch replacement and sized to fit in the cutouts found in residential interior doors.
The ‘face’ or baseplate of the Force Closer can have varying widths, rounded or squared corners, and be made of varying materials whether metal or plastic.
The ‘body’ of the Force Closer can be made of steel or a magnet with any degree of magnetism.
